(19) United States
(12) Patent Application Publication
(10) Pub. No.: US 2025/0147465 A1
(43) Pub. Date: May 8, 2025

(54) APPARATUS FOR RECORDING HOLOGRAM USING PHOTOPOLYMER COMPOSITION

(71) Applicant: KWANGWOON UNIVERSITY INDUSTRY-ACADEMIC COLLABORATION FOUNDATION, Seoul (KR)

(72) Inventors: SEUNGHYUN LEE, Namyangju-si (KR); LEEHWAN HWANG, Incheon (KR)

(21) Appl. No.: 18/424,659

(22) Filed: Jan. 26, 2024

(30) Foreign Application Priority Data
Nov. 7, 2023 (KR) 10-2023-0152913

(51) Int. Cl. G03H 1/04

(52) U.S. Cl. CPC G03H 1/0406; G03H 1/0465

(57) ABSTRACT

Disclosed herein is an apparatus for recording a hologram. The apparatus for recording a hologram according to the present specification may include a light source unit configured to illuminate an object with light, a housing having a predetermined shape and configured to block outside light, a coupling unit to which a recording medium having a photopolymer composition applied thereto is coupled, a lens unit positioned at a front surface of the housing and configured to form an image on the coupling unit, a filter unit, a backlight unit, and a controller.

### CROSS-REFERENCE TO RELATED APPLICATION

This application claims priority to and the benefit of Korean Patent Application No. 10-2023-0152913, filed on Nov. 7, 2023, the disclosure of which is incorporated herein by reference in its entirety.

### BACKGROUND

### 1. Field of the Invention

The present invention relates to an apparatus for recording a hologram, and more particularly, to an apparatus for recording a hologram using a photopolymer composition.

### 2. Discussion of Related Art

The contents disclosed in this section only provide background information on an embodiment disclosed in the present specification but do not necessarily constitute the related art.

A hologram is a recording of three-dimensional information on an object using an interference effect of light.

FIG. 1 is an image schematically illustrating an apparatus for recording a hologram according to the related art.

Referring to FIG. 1, in a conventional apparatus for recording a hologram, when an object is illuminated with light, object light, which is light reflected from the object, passes through a lens and enters the recording apparatus. The object light passes through a glass plate on which an emulsion composition has been applied and is diffusely reflected by mercury to form reference light. The object light and the reference light form an interference pattern, and the interference pattern is recorded in the emulsion composition.

In the related art, the reference light was generated by reflecting the object light onto mercury. Since an intensity of the reference light is approximately 2 to 3% of an intensity of the object light, a silver-halide emulsion with high light sensitivity was used to record the interference pattern. However, since the silver-halide emulsion is not widely produced, the supply is scarce, and the silver-halide emulsion needs to be developed and bleached after the interference pattern is recorded. In addition, the emulsion has a disadvantage in that it is difficult for a beginner to use because the interference pattern is not accurately recorded when the light is not absorbed in an appropriate amount or is overexposed.

### DOCUMENT OF RELATED ART

### [Patent Document]

(Patent Document 1) Korean Patent Publication No. 10-2002-0091855 (Dec. 11, 2002)

### SUMMARY OF THE INVENTION

The present specification is directed to providing an apparatus for recording a hologram.

The present specification is not limited to the aforementioned technical problems, and other technical problems, which are not mentioned above, may be clearly understood by those skilled in the art from the following descriptions.

An apparatus for recording a hologram according to the present specification includes a light source unit configured to illuminate an object with light, a housing having a predetermined shape and configured to block outside light, a coupling unit to which a recording medium having a photopolymer composition applied thereto is coupled, a lens unit positioned at a front surface of the housing and configured to form an image on the coupling unit, a filter unit positioned between the lens unit and the coupling unit and configured to block at least one wavelength region of a plurality of wavelength regions included in object light reflected from the object in response to a control signal, a backlight unit positioned at a rear surface of the coupling unit and configured to illuminate the coupling unit with reference light, and a controller configured to output a signal to control the light source unit, the filter unit, or the backlight unit.

According to one embodiment of the present specification, the filter unit may include a first filter configured to block a wavelength region having relatively highest optical sensitivity of the photopolymer composition among the plurality of wavelength regions, a second filter configured to block a wavelength region having lower optical sensitivity next to the wavelength region blocked by the first filter, and a third filter configured to block a wavelength region having relatively lowest optical sensitivity.

In this case, the filter unit may block a red region with the first filter, a green region with the second filter, and a blue region with the third filter.

According to another embodiment of the present specification, the filter unit may include a first filter configured to block a wavelength region having relatively highest optical sensitivity of the photopolymer composition among the plurality of wavelength regions, a second filter configured to block a wavelength region having lower optical sensitivity next to the wavelength region blocked by the first filter, and a third filter configured to block all wavelength regions.

In this case, the filter unit may block a red region with the first filter and a green region with the second filter.

According to one embodiment of the present specification, the controller may include a light source control module configured to output a control signal to regulate an intensity of illumination to the light source unit, a backlight control module configured to output a control signal to regulate an intensity of reference light to the backlight unit, and a filter control module configured to output an operation signal to the filter unit to block at least one wavelength region of the plurality of wavelength regions.

The apparatus for recording a hologram according to the present specification may further include a first optical sensor configured to output a measurement signal related to an intensity of the object light passing through the lens to the light source control module, the backlight control module, or the filter control module, wherein the light source control module may output a control signal such that the intensity of the object light is equal to or greater than a preset intensity.

According to one embodiment of the present specification, the backlight control module may receive a signal related to the intensity of the object light from the first optical sensor and output a control signal such that a difference in intensity of the object light and the reference light is within a preset threshold range.

The apparatus of recording a hologram according to the present specification may further include a second optical sensor configured to output a measurement signal related to the intensity of the reference light to the filter control module, wherein the filter control module may measure a photosensitization time for red, green, and blue regions of the plurality of wavelength regions when the difference in intensity of the object light and the reference light is within the preset threshold range, and output a control signal to block corresponding wavelength regions in sequence of the red, green, and blue regions, in which optical sensitivity of the photopolymer composition is relatively high.

According to one embodiment of the present specification, the filter control module may calculate the photosensitization time for each of the wavelength regions using a ratio of the optical sensitivities, and output a control signal to block the corresponding wavelength region when the calculated photosensitization time for each of the wavelength regions is exceeded.

Other detailed matters of the present invention are included in the detailed description and the drawings.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is an image schematically illustrating an apparatus for recording a hologram according to the related art;

FIG. 2 is an image schematically illustrating an apparatus for recording a hologram according to the present specification;

FIG. 3 is data on the amount of energy required for a commercial photopolymer composition according to one embodiment of the present specification to reach maximum refractive index modulation;

FIG. 4 is a block diagram of a controller according to one embodiment of the present specification; and

FIG. 5 illustrates an operation method of a filter unit through a filter control module, according to one embodiment of the present specification.

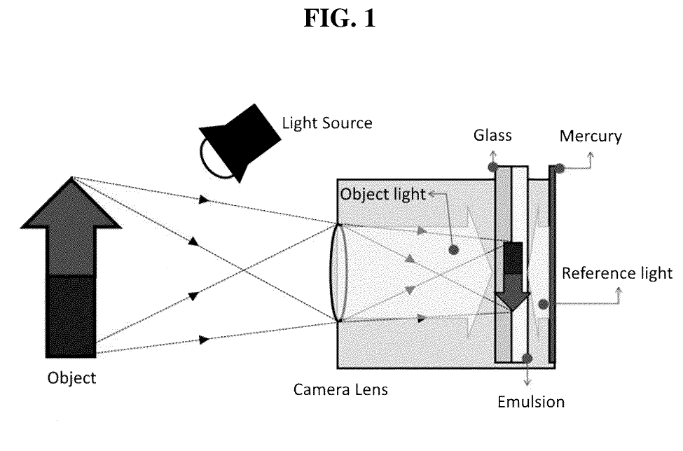

### DETAILED DESCRIPTION OF EXEMPLARY EMBODIMENTS

Advantages and features disclosed in the present specification and methods of achieving the advantages and features will be clear with reference to embodiments described in detail below together with the accompanying drawings. However, the present specification is not limited to the exemplary embodiments disclosed herein but will be implemented in various forms. The exemplary embodiments of the present specification are provided so that the present specification is completely disclosed, and a person with ordinary skill in the art can fully understand the scope of the present specification. The protection scope of the present specification will be defined only by the scope of the appended claims.

The terms used in the present specification are for explaining the exemplary embodiments, not for limiting the protection scope of the present specification. Unless particularly stated otherwise in the present specification, a singular form also includes a plural form. The term “comprise” and/or “comprising” used in the specification does not exclude existence or addition of one or more other constituent elements in addition to the mentioned constituent element.

Like reference denotations refer to like elements throughout the specification. As used herein, the term “and/or” includes each and all combinations of one or more of the mentioned constituent elements. Terms “first”, “second”, and the like may be used to describe various constituent elements, but the constituent elements are of course not limited by these terms. These terms are merely used to distinguish one constituent element from another constituent element. Therefore, the first constituent element mentioned hereinafter may of course be the second constituent element within the technical spirit of the present invention.

Unless otherwise defined, all terms (including technical and scientific terms) used in the present specification may be used as the meaning which may be commonly understood by the person with ordinary skill in the art to which the present specification pertains. In addition, terms defined in a generally used dictionary shall not be construed in ideal or excessively formal meanings unless they are clearly and specially defined in the present specification.

Hereinafter, an embodiment of the present invention will be described in detail with reference to the accompanying drawings.

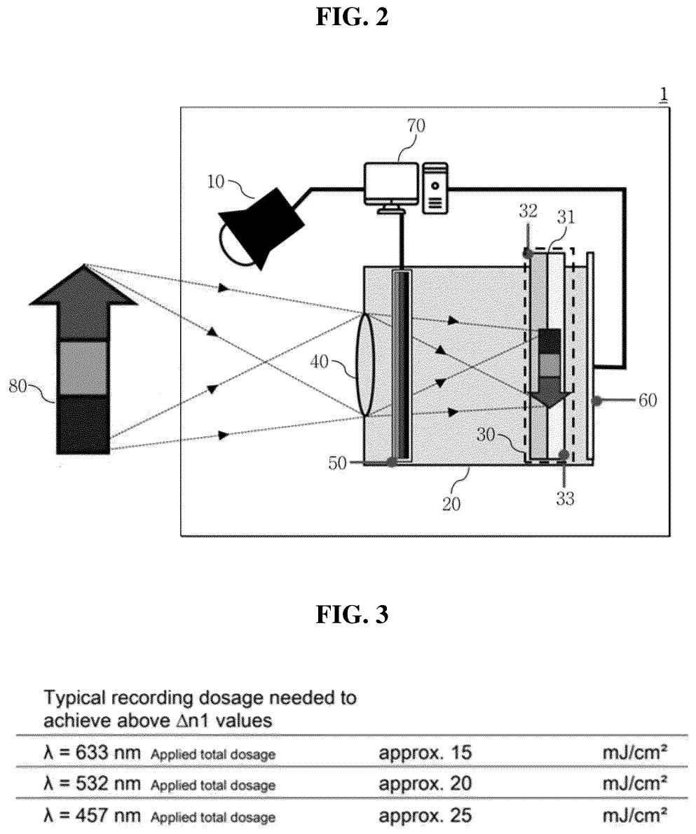

FIG. 2 is an image schematically illustrating an apparatus for recording a hologram according to the present specification.

Referring to FIG. 2, an apparatus 1 for recording a hologram according to the present specification may include a light source unit 10, a housing 20, a coupling unit 30, a lens unit 40, a filter unit 50, a backlight unit 60, and a controller 70.

The light source unit 10 may illuminate an object 80 with light. The light source unit 10 may output white light. In one example, the light source unit 10 may include red, green, and blue laser light sources. The white light illuminated by the light source unit 10 may be white light generated by mixing the respective laser light. This is just an example, and the light source unit 10 may correspond to any light source capable of generating white light having coherence.

The housing 20 has a predetermined shape and may block light that does not pass through the lens unit 40. The light passing through the lens unit 40 may be object light reflected from the object 80.

The coupling unit 30 may be positioned at a portion inside the housing 20, and a recording medium 31 for recording a hologram may be coupled thereto.

According to one embodiment of the present specification, the recording medium 31 may be a recording medium 31 with a photopolymer composition 33 applied to the rear surface of a glass substrate 32. This is an example, and the recording medium 31 may be in the form of the photopolymer composition 33 applied to a plastic film and/or a polymer film. In addition, the recording medium 31 may be configured only with the photopolymer composition 33. Accordingly, the recording medium 31 is not limited to a specific form and may correspond to any form that may be implemented using the photopolymer composition.

The lens unit 40 may be positioned at a front surface of the housing 20, and may allow an image to be formed by the object light on the recording medium 31 coupled to the coupling unit 30.

The filter unit 50 may be positioned between the lens unit 40 and the coupling unit 30, and may block at least one wavelength region of a plurality of wavelength regions included in the object light depending on a control signal. In one example, the filter unit 50 may include at least one color filter that blocks a specific color region. This is just an example, and not limited to any specific type of filter, and the filter unit 50 may employ any filter that blocks a specific wavelength region such as one or more band-pass filters and/or notch filters.

The backlight unit 60 may be positioned at a rear surface of the coupling unit 30, and may illuminate the recording medium 31 coupled to the coupling unit 30 with reference light. An interference pattern caused by the object light and the reference light may appear at a position where the recording medium 31 is coupled. A photopolymerization reaction may occur locally in the photopolymer composition 33 due to the interference pattern, and thus the interference pattern may be recorded on the photopolymer composition 33. An LED light source may be used in the backlight unit 60, which is just an example, and any light source that is capable of causing interference with the object light may be used.

The controller 70 may output a signal to control the light source unit 10, the filter unit 50, and/or the backlight unit 60. The controller 70 may output a control signal to the light source unit 10 and/or the backlight unit 60 such that the photopolymer composition 33 is illuminated with an amount of light required for the photopolymerization reaction. The controller 70 may output an operation signal to the filter unit 50 to block at least one wavelength region of the plurality of wavelength regions.

A chemical reaction may be generated by the interference pattern of the conventional silver-halide emulsion, and a hologram may be recorded. An amount of light energy required to record the interference pattern on the silver-halide emulsion is approximately 200 to 400 μJ/cm² of energy for each wavelength region.

FIG. 3 is data on the amount of energy required for a commercial photopolymer composition to reach a maximum refractive index modulation according to one embodiment of the present specification.

Referring to FIG. 3, according to one embodiment of the present specification, the amount of light energy in a red wavelength region (λ=633 nm) required for the commercial photopolymer composition to reach the maximum refractive index modulation is 15 mJ/cm², the amount of light energy in a green wavelength region (λ=532 nm) is 20 mJ/cm², and the amount of light energy in a blue wavelength region (λ=457 nm) is 25 mJ/cm². The reaching of the maximum refractive index modulation may mean that the commercial photopolymer composition is fully subjected to the photopolymerization reaction by light in each wavelength region.

A relatively greater amount of light may be required to record the interference pattern on the commercial photopolymer composition than the amount of light required to record the interference pattern on the silver-halide emulsion. The controller 70 may output a signal to regulate an intensity of the light source unit 10 and/or the backlight unit 60 in order to output the amount of light for recording the interference pattern on the photopolymer composition 33.

In addition, the amount of light energy required for the commercial photopolymer composition to reach the maximum refractive index modulation may be such that the amount of light energy in the red wavelength region is relatively the smallest, followed by the amount of light energy in the green wavelength region, and the amount of light energy in the blue wavelength region is relatively the greatest. This may mean that, when the amount of light energy for each of the wavelength regions illuminating the commercial photopolymer composition is equivalent, the photopolymerization reaction occurs relatively more in the commercial photopolymer composition by light in the red wavelength region, followed by the photopolymerization reaction by light in the green wavelength region, and the photopolymerization reaction occurs relatively the least by light in the blue wavelength region. This may mean that the commercial photopolymer composition has a relatively highest optical sensitivity to light in the red wavelength region, followed by a high optical sensitivity to light in the green wavelength region, and a relatively lowest optical sensitivity to light in the blue wavelength region.

When the photopolymerization reaction occurs in the photopolymer composition 33 due to the interference pattern caused by the object light and the reference light, a degree of the photopolymerization reaction may differ depending on the interference pattern caused by the red wavelength region, the green wavelength region, or the blue wavelength region of the object light. Accordingly, when a holographic image is output by illuminating the recording medium 31 on which the interference pattern is recorded with light, colors of the object 80 may not be clearly expressed in the holographic image. In one example, when the photopolymer composition 33 is the commercial photopolymer composition, a red color may be expressed relatively darkest, followed by a green color, and a blue color may be expressed relatively lightest among the colors of the holographic image.

The controller 70 may output a control signal to the filter unit 50 such that a difference in degree of photopolymerization reaction that occurs due to respective interference patterns by each wavelength region in the photopolymer composition 33 falls within a predetermined threshold range. The controller 70 may output a signal to the filter unit 50 to block corresponding wavelength regions in sequence of the highest optical sensitivity of the photopolymer composition among the plurality of wavelength regions included in the object light. The filter unit 50 may receive a signal to block a specific wavelength region of the object light from the controller 70 and block the corresponding wavelength region. Accordingly, the controller 70 may output a control signal to the filter unit 50 to regulate the amount of light of each wavelength region of the object light illuminated on the photopolymer composition 33, and to ensure that the difference in degree of the photopolymerization reaction occurring due to the respective interference patterns falls within the threshold range.

According to one embodiment of the present specification, the filter unit 50 may include a first filter configured to block a wavelength region having relatively highest optical sensitivity of the photopolymer composition 33 among the plurality of wavelength regions included in the object light, a second filter configured to block a wavelength region having lower optical sensitivity next to the wavelength region blocked by the first filter, and a third filter configured to block a wavelength region having relatively lowest optical sensitivity.

When the photopolymer composition 33 is the commercial photopolymer composition, the first filter may be a filter that blocks a red wavelength region (approximately 600 to 700 nm), the second filter may be a filter that blocks a green wavelength region (approximately 500 to 550 nm), and the third filter may be a filter that blocks a blue wavelength region (approximately 450 to 500 nm).

According to another embodiment of the present specification, the filter unit 50 may include a first filter configured to block a wavelength region having relatively highest optical sensitivity of the photopolymer composition 33 among the plurality of wavelength regions included in the object light, a second filter configured to block a wavelength region having the next highest optical sensitivity, and a third filter configured to block all wavelength regions.

When the photopolymer composition 33 is the commercial photopolymer composition, the first filter may be a filter that blocks the red region, and the second filter may be a filter that blocks the green region.

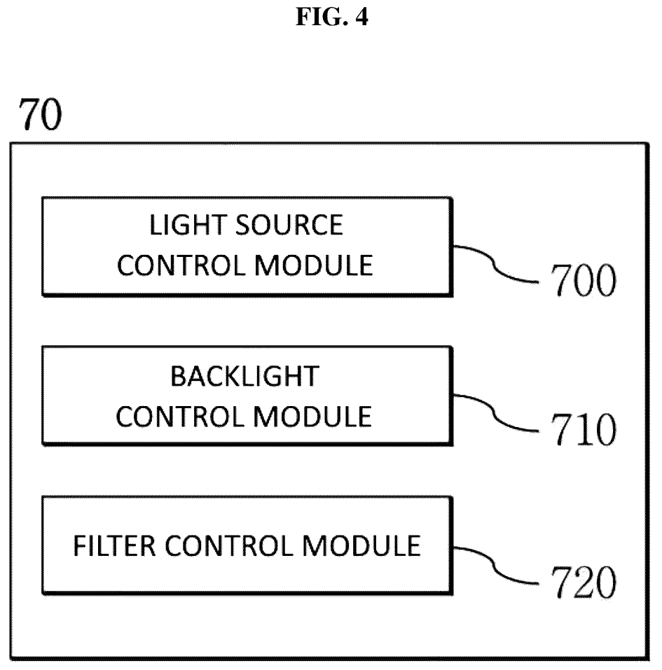

FIG. 4 is a block diagram of a controller according to one embodiment of the present specification.

Referring to FIG. 4, the controller 70 may include a light source control module 700, a backlight control module 710, and a filter control module 720.

The light source control module 700 may output a control signal to regulate an intensity of illumination to the light source unit 10.

The backlight control module 710 may output a control signal to regulate an intensity of the reference light to the backlight unit 60.

The filter control module 720 may output an operation signal to the filter unit 50 to block at least one wavelength region of the plurality of wavelength regions.

The light source control module 700 may output a control signal to the light source unit 10 such that an intensity of the object light is equal to or greater than a preset intensity.

An intensity reference of the object light may be set according to the optical sensitivity of the photopolymer composition 33. When the optical sensitivity of the photopolymer composition 33 is high, the preset intensity of the object light may be set relatively lower than when the photopolymer composition with low optical sensitivity is used. In contrast, when the optical sensitivity of the photopolymer composition 33 is low, the preset intensity of the object light may be set relatively higher than when the photopolymer composition with high optical sensitivity is used.

The apparatus 1 for recording a hologram may further include a first optical sensor (not illustrated) configured to output a measurement signal related to the intensity of object light passed through the lens to the light source control module 700. The light source control module 700 may receive the measurement signal from the first optical sensor and output a control signal to the light source unit 10 such that the intensity of the object light passed through the lens is greater than or equal to the preset intensity.

The backlight control module 710 may receive a signal related to the intensity of the object light from the first optical sensor and output a control signal to the backlight unit 60 such that a difference in intensity of the object light and the reference light is within a preset threshold range.

An interference pattern caused by two lights may appear relatively clearer as the wavelength and intensity of each light are similar. The interference pattern caused by the object light and the reference light may be recorded on the photopolymer composition 33. The backlight control module 710 may control the backlight unit 60 to output the reference light with an intensity similar to that of the object light, so that the interference pattern is relatively more clearly recorded on the photopolymer composition 33.

The filter control module 720 may measure a photosensitization time for the plurality of wavelengths when the difference in intensity of the object light and the reference light is within the preset threshold range. The apparatus 1 for recording a hologram may further include a second optical sensor (not illustrated) configured to output a measurement signal related to the intensity of the reference light to the filter control module 720.

The filter control module 720 may receive a signal related to the intensity of the object light from the first optical sensor. In addition, the filter control module 720 may receive a signal related to the intensity of the reference light from the first optical sensor. Then, it may be determined whether the difference in intensity of the object light and the reference light is within the preset threshold range. When the difference in intensity is within the threshold range, the filter control module 720 may measure the photosensitization time for the plurality of wavelength regions included in the object light. An occasion when the difference in intensity is within the threshold range may correspond to an occasion when the intensities of the object light and the reference light are similar and thus the interference pattern begins to be clearly generated. The plurality of wavelength regions may correspond to red, green, and blue wavelength regions.

When the photopolymer composition 33 is the commercial photopolymer composition, the filter control module 720 may output a control signal to the filter unit 50 to block corresponding wavelength regions in sequence of the red, green, and blue regions in which optical sensitivity is relatively high. The filter control module 720 may control the filter unit 50 such that the blue wavelength region of the object light is photosensitized for a relatively longest time and the red wavelength region is photosensitized for a relatively shortest time. The control signal may be output to the filter unit 50 after the filter control module 720 begins to measure the photosensitization time.

According to one embodiment of the present specification, the filter control module 720 may calculate the photosensitization time for each of the wavelength regions. The photosensitization time may be calculated using a ratio of the optical sensitivity for each wavelength region of the photopolymer composition 33. The filter control module 720 may output a control signal to the filter unit 50 to block a corresponding wavelength region when the measured photosensitization time for each wavelength region included in the object light exceeds the calculated photosensitization time.

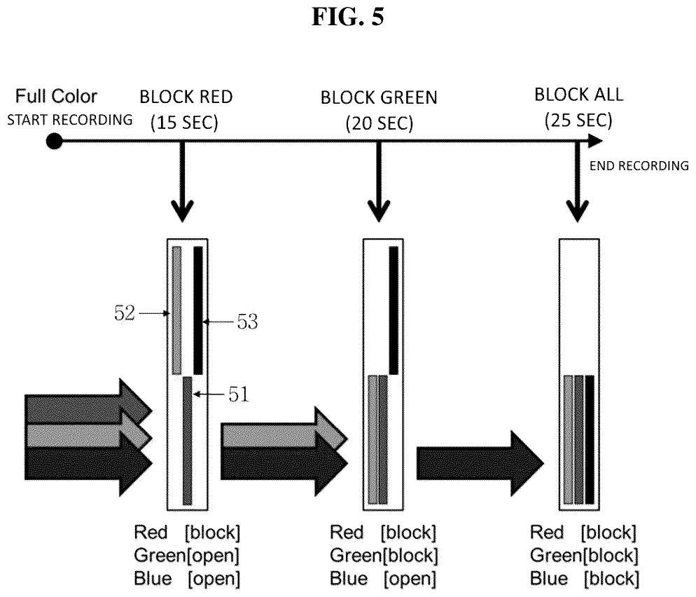

FIG. 5 illustrates an operation method of a filter unit through a filter control module, according to one embodiment of the present specification.

Referring to FIG. 5, the filter control module 720 may output an operation signal to the filter unit 50 in order to control the degree of photopolymerization reaction that occurs due to the interference pattern according to each wavelength region of the photopolymer composition 33. When the photopolymer composition 33 is the commercial photopolymer composition, the filter unit 50 may include a first filter 51 configured to block the red wavelength region of the object light, a second filter 52 configured to block the green wavelength region, and a third filter 53 configured to block the blue wavelength region or all wavelength regions.

The filter control module 720 may receive data on the optical sensitivity of the commercial photopolymer composition, which is illustrated in FIG. 3 as input. The filter control module 720 may calculate a photosensitization time for light in each wavelength region based on the ratio of the optical sensitivity to each wavelength region.

In one example, the filter control module 720 may calculate a photosensitization time for the red wavelength region to be 15 seconds, a photosensitization time for the green wavelength region to be 20 seconds, and a photosensitization time for the blue wavelength region to be 25 seconds based on the ratio. In addition, the photosensitization time for each wavelength region may be calculated to be relatively longer time or shorter time, while maintaining the ratio of the photosensitization time depending on the intensity of the object light and/or the reference light. Furthermore, the calculated photosensitization time may vary depending on the characteristics of the photopolymer composition 33.

The filter control module 720 may start to record the photosensitization time for each wavelength region when the difference in intensity of the object light and the reference light is within the threshold range.

When 15 seconds have elapsed since the recording of the photosensitization time started, the filter control module 720 may output a signal to operate the first filter 51 to the filter unit 50. The filter unit 50 may operate the first filter 51 to block the red wavelength region of the object light.

When 20 seconds have elapsed since the recording of the photosensitization time started, the filter control module 720 may output a signal to operate the second filter 52 to the filter unit 50. The filter unit 50 may operate the second filter 52 to block the green wavelength region of the object light.

When 25 seconds have elapsed since the recording of the photosensitization time started, the filter control module 720 may output a signal to operate the third filter 53 to the filter unit 50. The filter unit 50 may operate the third filter 53 to block the blue wavelength region or all wavelength regions of the object light.

The present specification has been described assuming that a commercial photopolymer composition HX200 is used as the photopolymer composition of the apparatus for recording a hologram. However, this is just an example and different photopolymer compositions may be used. When different photopolymer compositions are used, the wavelength region blocked by the first filter, the second filter, and the third filter may vary depending on the optical sensitivity of the composition. In addition, depending on the ratio of the optical sensitivity, the photosensitization time and the ratio of the photosensitization time of light in each wavelength region may vary. Accordingly, it is obvious that the present invention is not limited to HX200, which is a commercial photopolymer, and that various embodiments may arise depending on the properties of the photopolymer composition.

The controller 70 may include a processor, an application-specific integrated circuit (ASIC), other chipsets, a logic circuit, a register, a communication modem, a data processing device, or the like known in the art to which the present invention belongs, for performing calculations and various control logic. In addition, when the control logic described above is implemented in software, the controller 50 may be implemented as a set of program modules. In this case, the program module is stored in a memory device and may be executed by the processor.

According to one aspect of the present specification, a photopolymer composition can be used to record a hologram more easily than the related art.

According to another aspect of the present specification, a photopolymer composition can be more eco-friendly than the related art because no separate development and bleaching processes are required when the photopolymer composition is used.

The effects of the present invention are not limited to the aforementioned effects, and other effects, which are not mentioned above, will be clearly understood by those skilled in the art from the following description.

While the embodiments of the present specification have been described with reference to the accompanying drawings, those skilled in the art will understand that the present specification may be carried out in any other specific form without changing the technical spirit or an essential feature thereof. Therefore, it should be understood that the above-described embodiments are illustrative in all aspects and do not limit the present invention.

What is claimed is:

1. An apparatus for recording a hologram, comprising:
a light source unit configured to illuminate an object with light;
a housing having a predetermined shape and configured to block outside light;
a coupling unit to which a recording medium having a photopolymer composition applied thereto is coupled;
a lens unit positioned at a front surface of the housing and configured to form an image on the coupling unit;
a filter unit positioned between the lens unit and the coupling unit and configured to block at least one wavelength region of a plurality of wavelength regions included in object light reflected from the object in response to a control signal;
a backlight unit positioned at a rear surface of the coupling unit and configured to illuminate the coupling unit with reference light; and
a controller configured to output a signal to control the light source unit, the filter unit, or the backlight unit.

2. The apparatus of claim 1, wherein the filter unit includes:
a first filter configured to block a wavelength region having relatively highest optical sensitivity of the photopolymer composition among the plurality of wavelength regions;
a second filter configured to block a wavelength region having lower optical sensitivity to the wavelength region blocked by the first filter; and
a third filter configured to block a wavelength region having relatively lowest optical sensitivity.

3. The apparatus of claim 2, wherein the filter unit blocks a red region with the first filter, a green region with the second filter, and a blue region with the third filter.

4. The apparatus of claim 1, wherein the filter unit includes:
a first filter configured to block a wavelength region having relatively highest optical sensitivity of the photopolymer composition among the plurality of wavelength regions;
a second filter configured to block a wavelength region having the next highest optical sensitivity to the wavelength region blocked by the first filter; and
a third filter configured to block all wavelength regions.

5. The apparatus of claim 4, wherein the filter unit blocks a red region with the first filter and a green region with the second filter.

6. The apparatus of claim 1, wherein the controller includes:
a light source control module configured to output a control signal to regulate an intensity of illumination to the light source unit;
a backlight control module configured to output a control signal to regulate an intensity of reference light to the backlight unit; and
a filter control module configured to output an operation signal to the filter unit to block at least one wavelength region of the plurality of wavelength regions.

7. The apparatus of claim 6, further comprising a first optical sensor configured to output a measurement signal related to an intensity of the object light passing through the lens to the light source control module, the backlight control module, or the filter control module,
wherein the light source control module outputs a control signal such that the intensity of the object light is equal to or greater than a preset intensity.

8. The apparatus of claim 7, wherein the backlight control module receives a signal related to the intensity of the object light from the first optical sensor and outputs a control signal such that a difference in intensity of the object light and the reference light is within a preset threshold range.

9. The apparatus of claim 6, further comprising a second optical sensor configured to output a measurement signal related to the intensity of the reference light to the filter control module,
wherein the filter control module measures a photosensitization time for red, green, and blue regions of the plurality of wavelength regions when the difference in intensity of the object light and the reference light is within the preset threshold range, and outputs a control signal to block corresponding wavelength regions in sequence of the red, green, and blue regions in which optical sensitivity of the photopolymer composition is relatively high.

10. The apparatus of claim 9, wherein the filter control module calculates the photosensitization time for each of the wavelength regions using a ratio of the optical sensitivities, and outputs a control signal to block the corresponding wavelength region when the calculated photosensitization time for each of the wavelength regions is exceeded.
